(19) United States
(12) Patent Application Publication
(10) Pub. No.: US 2013/0031022 A1
(43) Pub. Date: Jan. 31, 2013

(54) GENERATING UPDATED DATA FROM EXTREME HETEROGENEOUS DATA

(71) Applicant: Daniel Satchkov, Bayside, NY (US)

(72) Inventor: Daniel Satchkov, Bayside, NY (US)

(73) Assignee: Rixtrema Inc., Bayside, NY (US)

(21) Appl. No.: 13/562,268

(22) Filed: Jul. 30, 2012

Related U.S. Application Data
(60) Provisional application No. 61/513,162, filed on Jul. 29, 2011.
(60) Provisional application No. 61/513,158, filed on Jul. 29, 2011.

(51) Int. Cl. G06Q 40/06

(52) U.S. Cl. 705/36 R

(57) ABSTRACT

Systems, methods and apparatus are provided through which in some implementations a method of calculating risk of a financial asset by using performance data on past returns, include over-weighting high and low performance periods in the financial asset performance data, and generating an instability estimator of a risk statistic of the financial asset performance data in reference to the over-weighted high and low performance periods.

### RELATED APPLICATION

This application claims the benefit of U.S. Provisional Application Ser. No. 61/513,158 filed 29 Jul. 2011 under 35 U.S.C. 119(e).

### FIELD

This disclosure relates generally to variable analysis, and more particularly to instability estimates.

### BACKGROUND

Forecasts of any statistic use past observations of some performance parameter of an asset The forecasts can provide (through mathematical methods applied through computer algorithms) more or less importance to some observations, which will change the resulting risk forecast. One example of assigning more importance to some observations is to use time as the importance criteria, i.e. more recent observations get more (or less) importance. In this way, a risk forecast will differ from the forecast in which all observations are treated as equally important. Another commonly used risk forecast simply assigns equal weights to the history of returns.

Examples of risk statistics are VaR (Value-at-Risk), tracking error, expected tail loss and conditional value-at-risk.

### BRIEF DESCRIPTION

This disclosure is applicable to all methods of forecasting risk of a financial instrument (or a group of financial instruments that is usually called ‘a portfolio”) that use historical data on performance of such instrument(s), most commonly: price, returns, volatility.

In one aspect, a method of calculating risk of a financial asset by using performance data on past returns includes over-weighting high and low performance periods in financial asset performance data and generating an instability estimator of a risk statistic of the financial asset performance data in reference to the over-weighted high and low performance periods.

In another aspect, a system to transact in electronic commerce includes a processor, a storage device coupled to the processor, operable to store heterogeneous financial data of an item and variance rules, a weighting engine that is operable on the processor to receive, distinguish and identify extreme heterogeneous financial data and over-weight the extreme heterogeneous financial data, an analytical engine that is operable on the processor to receive the over-weighted extreme heterogeneous financial data, the variance rules, and the heterogeneous financial data, and operable on the processor to perform the variance rules on the heterogeneous financial data using the over-weighted extreme financial data to generate or yield an instability estimator.

In a further aspect, a method of determining variance in heterogeneous data, the heterogeneous data including a time dimension and a magnitude dimension, the method includes storing an electronically accessible database of the heterogeneous data in a system, the system including at least one computing device with a processor and memory, the memory storing executable instructions that are executable by the processor, determining the magnitude dimension that is associated with the time dimension having distinguishing extreme magnitudes of the heterogeneous data in the electronically accessible database, the distinguishing extreme magnitudes being stored in the memory of the system, generating a weight of the heterogeneous data of the time dimension having the distinguishing extreme magnitudes in the memory of the system more than the heterogeneous data outside of the time dimension distinguishing extreme magnitudes of the heterogeneous data in the memory of the system, and generating an estimated risk of the heterogeneous data in the electronically accessible database in the system in reference to the weight in the memory of the system.

In yet another aspect, a method of determining variance in heterogeneous data, the heterogeneous data including a time dimension and a performance measurement, the method includes storing an electronically accessible repository of the heterogeneous data in a system, the system including at least one computing device with a processor and memory, the memory storing executable instructions that are executable by the processor, identifying unstable periods of the performance measurement of the heterogeneous data of the electronically accessible repository in the system, generating a weight of the heterogeneous data of the time dimension having the unstable periods of the performance measurement of the heterogeneous data of the electronically accessible repository in the memory of the system, generating an instability estimator of a risk statistic of the heterogeneous data of the electronically accessible repository of the system in reference to the weight.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system to calculate variance of heterogeneous performance data that changes weighting of past returns, according to an implementation;

FIG. 2 is a flowchart of a method of calculating risk of an asset by using performance data on past returns, according to an implementation;

FIG. 3 is a flowchart of a method, according to an implementation;

FIG. 4 is a flowchart of a method of generating the weighting, according to an implementation;

FIG. 5 is a flowchart of a method of identifying unstable periods, according to an implementation;

FIG. 6 is a flowchart of a method of generating instability estimator in reference to a weighted extreme period, according to an implementation;

FIG. 7 is a flowchart of a method of determining variance in heterogeneous data;

FIG. 8 is a method of generating the estimated risk of the heterogeneous data in the electronically accessible database in the system in reference to the weight in the memory of the system; and

FIG. 9 is a block diagram of a hardware and operating environment in which different implementations can be practiced.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, implementations of methods are described. In the third section, a hardware and the operating environment in conjunction with which implementations may be practiced are described. Finally, in the fourth section, a conclusion of the detailed description is provided.

### System Level Overview

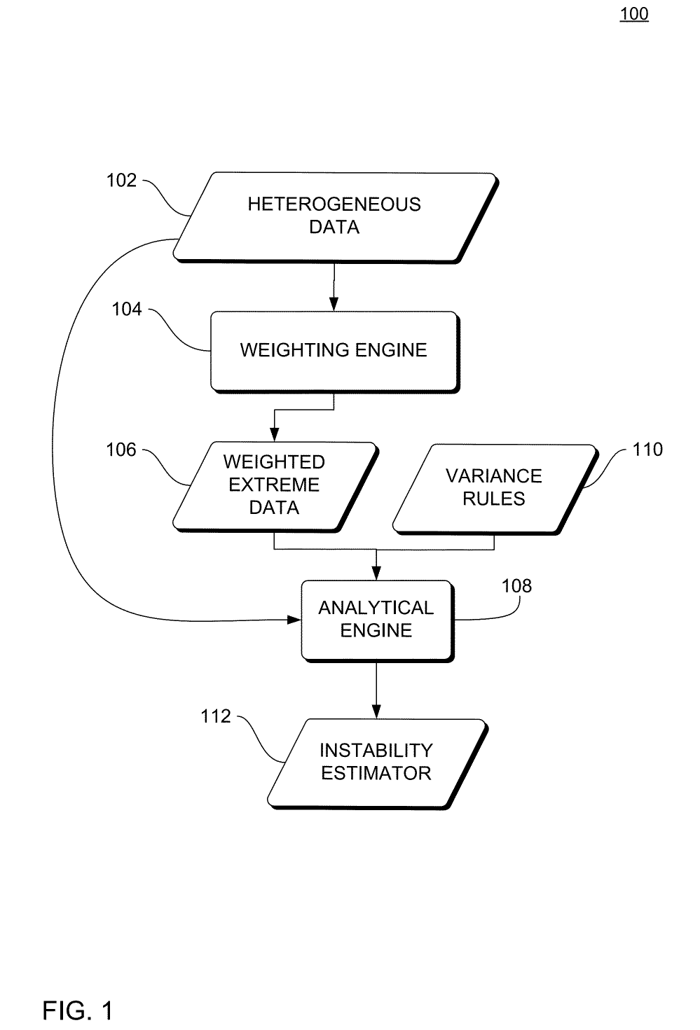

FIG. 1 is a block diagram of an overview of a system 100 to calculate variance of heterogeneous performance data that changes weighting of past returns, according to an implementation. System 100 distinguishes between observations that vary greatly from the mean or median observations that more accurately predicts forthcoming periods that vary greatly from the mean or median observations. System 100 includes heterogeneous financial data 102 that is received by a weighting engine 104. In general, an engine is a component that performs a very specific and repetitive function in contrast to a component that has many functions. In the example of the weighting engine 104, the weighting engine 104 distinguishes, identifies and over-weights the heterogeneous financial data 102 that vary greatly from the mean or median of the heterogeneous financial data 102. Over-weighted data is data having disproportionately higher numerical weighting or representation. The heterogeneous financial data 102 that vary greatly from the mean or median of the heterogeneous financial data 102 is often called ‘extreme’ data. The extreme data is over-weighted 106 to increase the numerical importance and significance in further analysis. An analytical engine 108 receives the over-weighted extreme financial data 106, variance rules 110 and the heterogeneous financial data 102. Examples of the variance rules 110 are VaR (Value-at-Risk), tracking error, expected tail loss and conditional value-at-risk. VaR is a measure of the risk of loss on a specific portfolio of financial assets. For a given portfolio, probability and time horizon. VaR is defined as a threshold value such that the probability that the mark-to-market loss on the portfolio over the given time horizon exceeds this value (assuming normal markets and no trading in the portfolio) is the given probability level. Tracking error (also called active risk) is a measure of how closely a portfolio follows an index to which the portfolio is benchmarked. The best measure of tracking error is the root-mean-square of the difference between the portfolio and index returns. Expected tail loss (ETL) a measure of risk to evaluate the market risk or credit risk of a portfolio. ETL (also known as expected shortfall, conditional value at risk (CVaR) and average value at risk (AVaR) is more sensitive to the shape of the loss distribution in the tail of the distribution. The ETL at Q % level is the expected return on the portfolio in the worst Q % of the cases. ETL evaluates the value (or risk) of an investment in a conservative way, focusing on the less profitable outcomes. For high values of Q, ETL ignores the most profitable but unlikely possibilities, for small values of Q, ETL focuses on the worst losses. On the other hand, unlike the discounted maximum loss even for lower values of Q, the expected shortfall does not consider only the single most catastrophic outcome. A value of Q often used in practice is 5%. ETL is a coherent, and moreover a spectral, measure of financial portfolio risk. ETL requires a quantile-level Q, and is defined to be the expected loss of portfolio value given that a loss is occurring at or below the Q-quantile. The analytical engine 108 performs the variance rules on the heterogeneous financial data 102 using the over-weighted extreme financial data 106 to generate or yield an instability estimator 112. The instability estimator 112 is a guide or leading indicator of future periods of extreme activity of the item measured by the heterogeneous financial data 102. While the system 100 is not limited to any particular heterogeneous financial data 102, weighting engine 104, the over-weighted extreme financial data 106, analytical engine 108, variance rules 110 and instability estimator 112, for sake of clarity a simplified heterogeneous financial data 102, weighting engine 104, the over-weighted extreme financial data 106, analytical engine 108, variance rules 110 and instability estimator 112 are described.

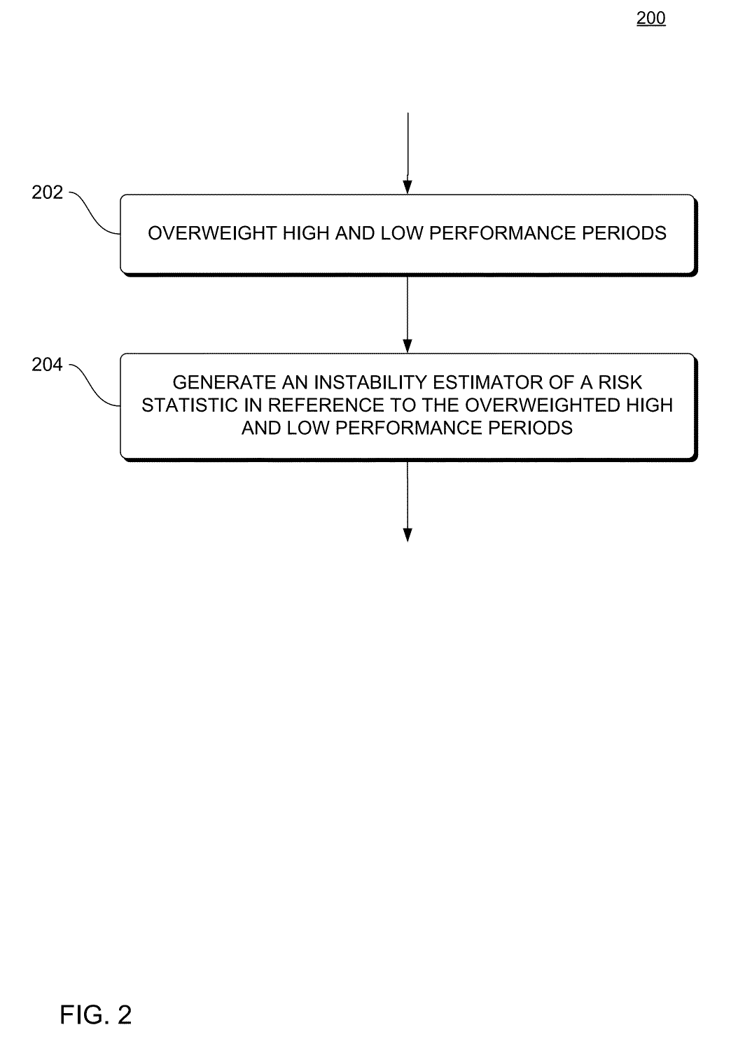

System 100 in FIG. 1 and methods 200-800 in FIG. 2-8 provide more importance to observations of the performance of an asset that come from “extreme” periods vs. other observations when certain conditions warrant. These conditions are used to regulate the weighting of the past data in the risk model. “Asset” is used in this disclosure as a synonym for “financial instrument” or a group of financial instruments usually called “a portfolio”. Performance can be expressed in any financial term that shows the historical “behavior” of an asset. Examples: price, price fluctuations (difference in price between certain dates), price growth (between certain dates), returns, volatility, etc. System 100 in FIG. 1 and methods 200-800 in FIG. 2-8 determines when and how to assign progressively high importance to extreme observations (i.e. the conditions that are warranted). In order to perform such assignment, system 100 in FIG. 1 and methods 200-800 in FIG. 2-8 can use additional factors beyond the historic performance of an asset (or a group of assets). In some implementations system 100 in FIG. 1 and methods 200-800 in FIG. 2-8 assume that any crisis is driven by the behavior of financial market participants and the design of the financial system and that before the crisis expresses itself in the performance parameter (e.g. corporate financial data or stock performance metrics such as price and volatility) of an asset (the asset that is experiencing, or about to experience, a crisis), the crisis is expressed in the behavior of the participants that can be measured by those additional factors referred to in this paragraph above. Below are some examples of the factors that influence the risk forecast and therefore system 100 in FIG. 1 and methods 200-800 in FIG. 2-8 use the factor for assigning higher importance to performance observations from the extreme portion of the sample. System 100 in FIG. 1 and methods 200-800 in FIG. 2-8 are applicable to asset classes such as equity, commodities, corporate fixed income, sovereign fixed income. The factors include but are not limited to:
Relevant P/E (for S&P, or Sector (e.g. industrials, financial, etc., or Country)
Junk (also called high yield) credit spread
Junk credit spread change over some period of time
Price proximity to inflation-adjusted high (i.e. highest price)
Some measure of capital inflows into a country. For example, a rolling sum of the ratio of [Total Capital Inflow into a country]/[country GDP] over some period of time or a rolling sum of the ratio of [Short-term Capital Inflow into a country]/[country GDP] over some period of time
Some measure of leverage of the market. For example, ratio of [debt (just external, or just internal, or external+internal) of the economy of a country]/[exports of the country over some period of time] or change of debt (just external, or just internal, or external+internal) of the economy of a country over some period of time] divided by [change in exports of the country over some period of time]
Change in the yield of sovereign debt of a country over some period of time
Change in exchange rate (nominal or real) of the currency of a country over some period of time
Option-Adjusted Spread (for relevant sector)
Change in Option-Adjusted Spread (for relevant sector) over some period of time
Housing price to rent ratios
Financial sector leverage

Additional applications of system 100 in FIG. 1 and methods 200-800 in FIG. 2-8:
Estimation of any financial risks. For example, system 100 in FIG. 1 and methods 200-800 in FIG. 2-8 can be used to improve the multi-factor risk models by changing the way that the data is utilized by those models.
Improving the pricing of derivatives that are based on volatility of financial instruments, because the method helps to forecast volatility more accurately.
Improve the quality of the covariance matrices used for forecasting of the tracking error and in optimization algorithms if applied to the estimation of marginal future distributions of factors or assets.

### Method Implementations

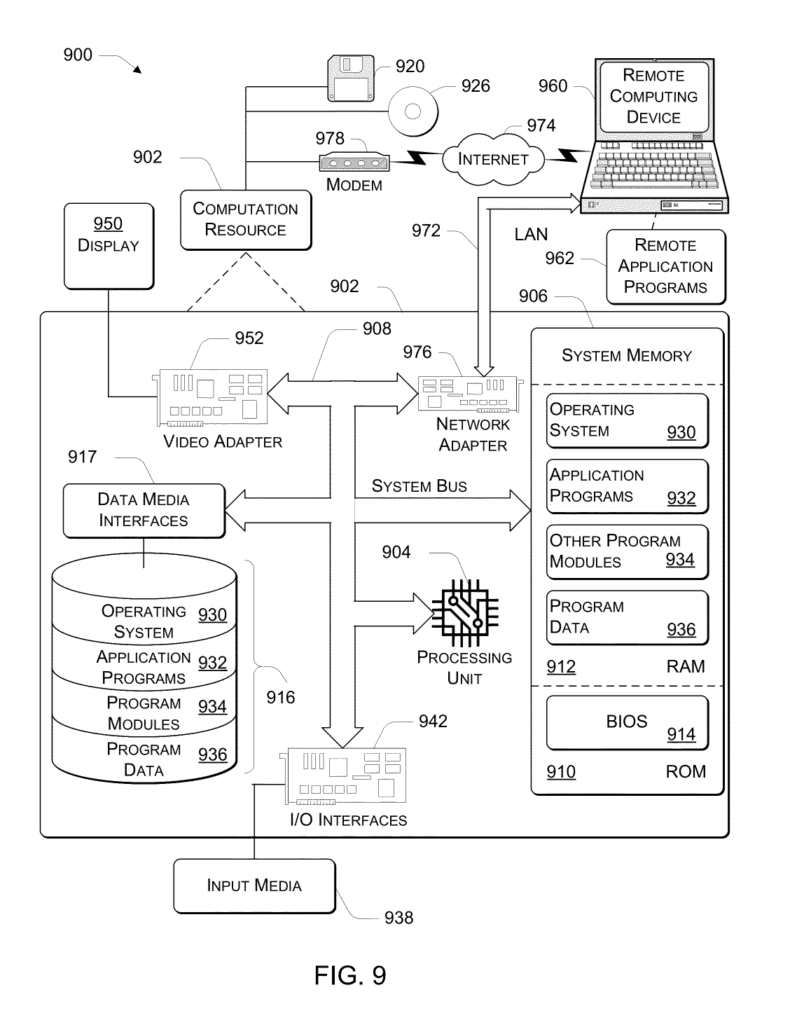

In the previous section, a system level overview of the operation of an implementation is described. In this section, particular methods of implementations are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 200-800 are performed by a program executing on, or performed by firmware or hardware that is a part of, a computer, such as general computer environment 900 in FIG. 9.

FIG. 2 is a flowchart of a method 200 of calculating risk of a financial asset performance data that changes weighting of past returns, according to an implementation.

Some implementations of method 200 include over-weighting high and low performance periods in the financial asset performance data, at block 202.

Some implementations of method 200 include generating an instability estimator of a risk statistic of the financial asset performance data in reference to the over-weighted high and low performance periods, at block 204. Some examples of risk statistics are VaR (Value-at-Risk), Tracking Error, expected tail loss, conditional value-at-risk, among others. This disclosure is applicable to all methods of forecasting risk of a financial instrument (or a group of financial instruments that is usually called ‘a portfolio”) that use historical data on performance of such instrument(s), most commonly: price, returns, volatility. Method 200 distinguishes between observations that come from “extreme” periods of high and low magnitudes of financial asset performance data. In some implementations, extreme periods for this definition are all observations that are beyond 2 standard deviations from the mean of all observations for which the data is publicly available). When markets are tranquil and realized volatility is low, this leads to a low risk forecast. Thus method 200 does not understate a risk forecast before a new “extreme” period of price volatility occurs.

In one example, generating an instability estimator at block 204, the metric VaR (though any other metric can be used) is implemented. The specific mathematical formulas used below are one technique of generating an instability estimator. In the interest of simplicity, the most basic and perhaps most widely used type of VaR, the parametric VaR is implemented with the equal weighted (EW) and decay time weighted (DTW) methods of using the past data for estimation. Then an instability estimator of parametric VaR is introduced. The instability estimator captures tail risks even with a simplistic parametric VaR. Construction of the instability estimator of parametric VaR is described as:

$${}_{ }^{INST}{σ}{}_{j , k}^{2} = {W}_{EX} * \frac{1}{n} * {\sum }_{t = 1}^{c} [ {r}_{j , t}^{EX} * {r}_{k , t}^{EX} ] + ( 1 - {W}_{EX} ) * ( {}_{ }^{EW}{σ}{}_{j , k}^{2} )$$

Where:

W_{EX}—Weight assigned to the extreme observations. Similar to EVT methods, in order to find enough of these extreme observations one must widen the available sample as much as possible. The available sample for extreme observations starts Dec. 31, 1930.

c—is the number of observations that satisfy the criteria to be chosen as extreme data points

r_{j,i}^{EX}—selected extreme period return of the of asset j or k at time t

And the Instability estimator of Parametric VaR for asset j:

VaR=k*(^{INST}σ_{j,j})

Where:

k—scaling based on the confidence level of VaR

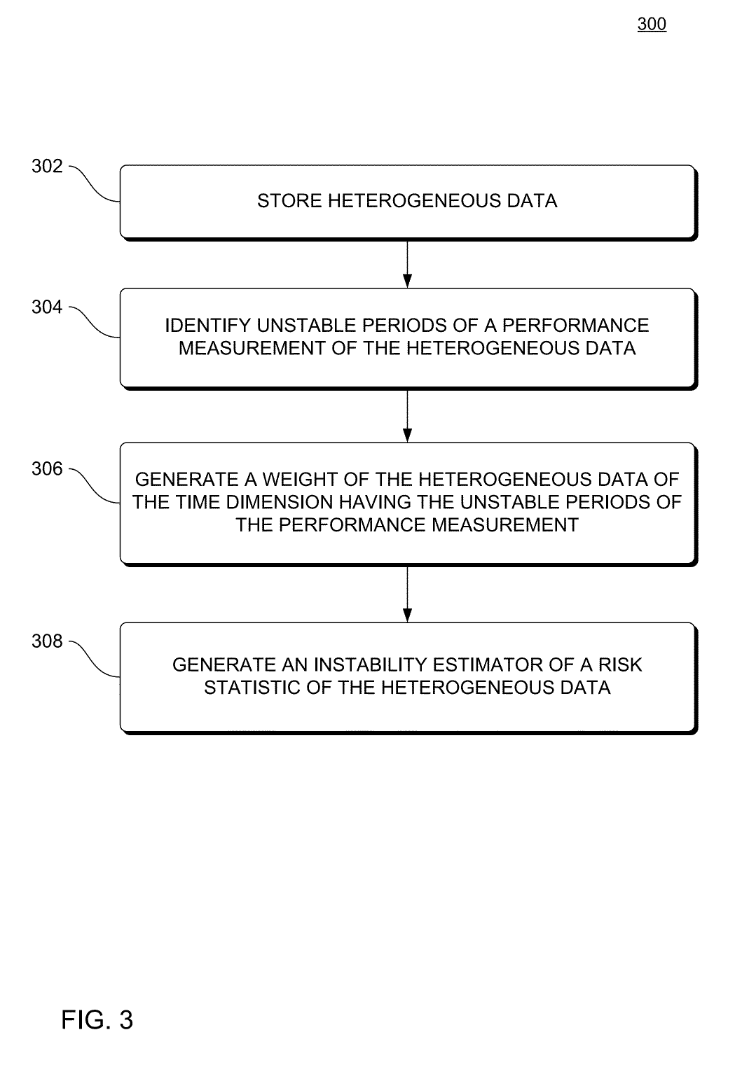

FIG. 3 is a flowchart of a method 300, according to an implementation. Method 300 determines variance in financial data, or other heterogeneous data. The financial data includes performance measurement data that has a time dimension.

Some implementations of method 300 include storing an electronically accessible repository of the financial data in a system, at block 302. The system includes at least one computing device with a processor and memory, such as shown in FIG. 9. The memory stores executable instructions that are executable by the processor.

Some implementations of method 300 include identifying unstable periods of the performance measurement of the financial data of the electronically accessible repository in the system, at block 304.

Some implementations of method 300 include generating a weight of the financial data of the time dimension that has the unstable periods of the performance measurement of the financial data of the electronically accessible repository in the memory of the system, at block 306.

Some implementations of method 300 include generating an instability estimator of a risk statistic of the financial data of the electronically accessible repository of the system in reference to the weight, at block 308.

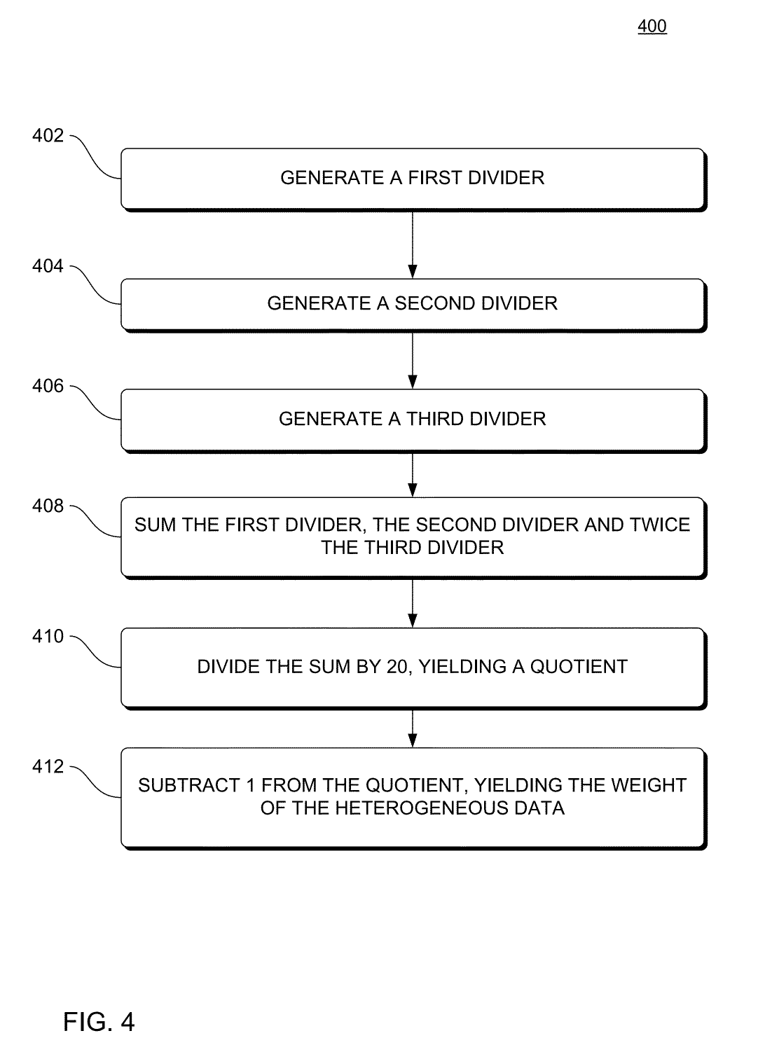

FIG. 4 is a flowchart of a method 400 of generating the weighting, according to an implementation.

Some implementations of method 400 include generating a first decile, divider or other separator, at block 402. The first decile includes a reverse decile of a 1 year average price/earnings ratio in a historical sample of average price/earnings ratio.

Some implementations of method 400 include generating a second decile, divider or other separator, at block 404. The second decile includes a decile of a 1 year average junk spread.

Some implementations of method 400 include generating a third decile, dividor or other separator, at block 406. The third decile includes a reverse decile of 180-day change in average 1-year junk spreads, at the time at which the price/earnings ratio of the financial data is observed.

Some implementations of method 400 include summing the first decile, the second decile and twice the third decile, at block 408.

Some implementations of method 400 include dividing the sum by 20, yielding a quotient, at block 410.

Some implementations of method 400 include subtracting 1 from the quotient of the dividing, yielding the weight of the financial data in the electronically accessible repository in the system 412.

One implementation of the weighting function of method 400 is:

$${W}_{EX , i} = MIN ( MAX ( \frac{D {C}_{PE , i} + D {C}_{JS , i} + 2 * D {C}_{Δ JS , i}}{20} , 1 ) - 1 , .3 )$$

where:

i—time at which the PE is observed and VaR is estimated

risk mispricing mMetrics:

DC_{PE,i}—reverse decile of 1 year average PE in a historical sample of all such average PE's; where deciles are made fractional through multiplying decimal percent ranks by 10, i.e. a percent rank of 1 (highest possible value) becomes decile rank (that is reverse decile) of 10 (highest possible contribution to weight)

DC_{JS,i}—decile of 1 year average junk spread

risk mispricing reversal metric:

DC_{ΔJS,i}—reverse decile of 180 day change in the average 1 year junk spreads. Sources of data are Standard and Poors, Merrill Lynch, Haver Analytics

Using this weighting function, the weight of extreme periods should be highest when smoothed price/earnings (PE) ratio is high, smoothed junk spreads (JS) are low and 180 day change in smoothed junk spreads (DJS) in high (i.e. spreads are trending up after a period of risk mispricing). The combined weight of PE and JS as representing risk mispricing is equal to one half, while the weight of DJS, as representing the warning of the end of mispricing, is also equal to one half. The combined deciles are divided by 20 and 1 is subtracted from the total. The highest possible value of the sum of deciles is 40, so the weight of the extreme sample will vary from zero to one directly proportionally with the increase in the sum of deciles of the original signals. The maximum function ensures that when the sum of signals is below 20, the weight is zero and not negative, while the minimum function caps the total weight of the extreme periods to thirty percent of the sample to avoid calculating VaR based on only a small number of observations in the tail¹. The weighting formula above occupies in the IER paradigm the same place occupied by the exponential decay weighting in the presently accepted one, that is, the purpose is to indicate which periods carry more valuable information. The present paradigm assumes that recent periods are always more valuable, while the IER is based on the assumptions that there are other factors that govern this relative importance of data points.

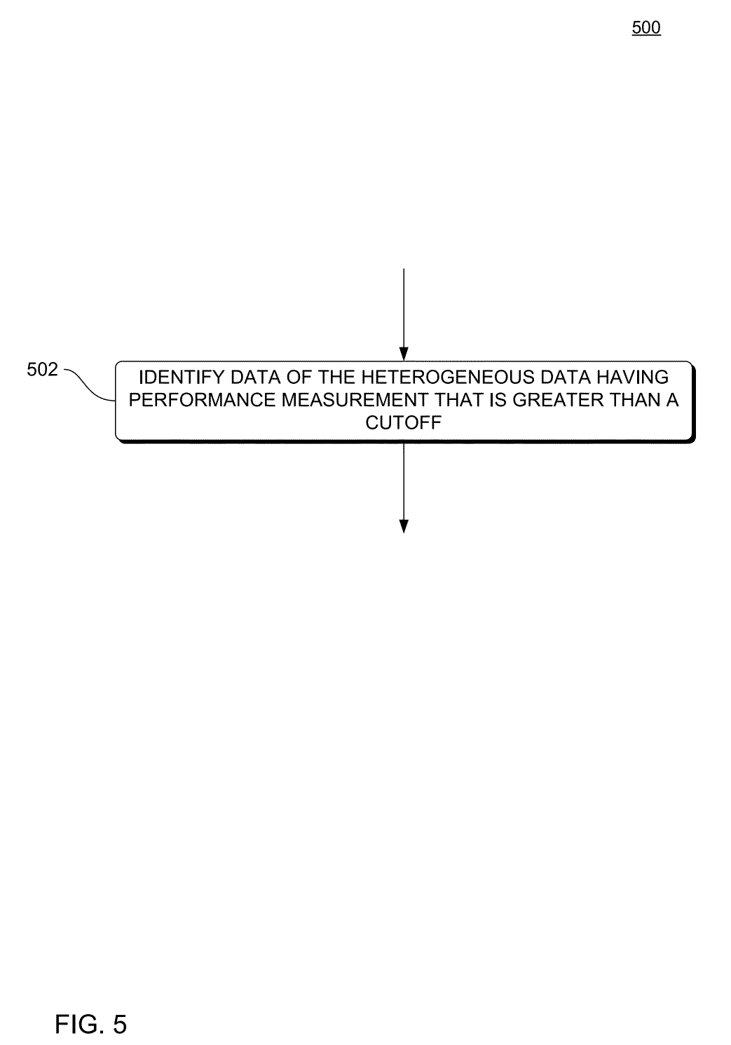

FIG. 5 is a flowchart of a method 500 of identifying unstable periods 500, according to an implementation.

Some implementations of method 500 include identifying data of the financial data that has performance measurement that is greater than a predetermined cutoff value, at block 502. In some implementations the predetermined cutoff value is 2 standard deviations.

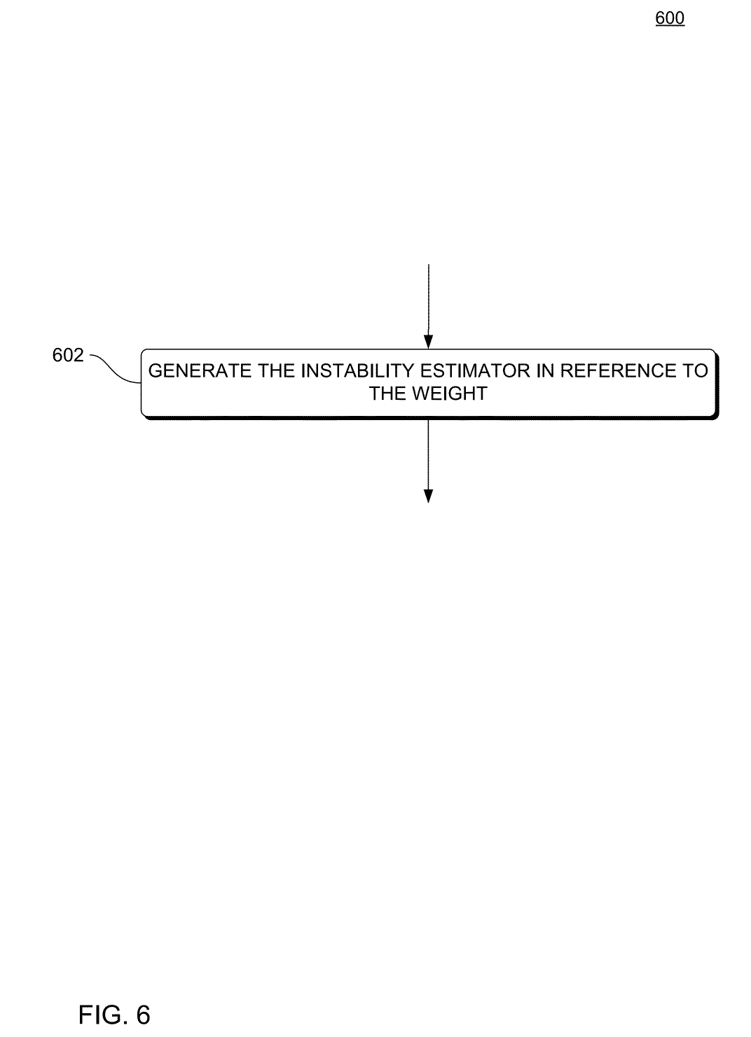

FIG. 6 is a flowchart of a method 600 of generating instability estimator in reference to a weighted extreme period, according to an implementation. Some implementations of method 600 include generating the instability estimator in reference to the weight of the financial data of the time dimension that has the unstable periods in the memory of the system, a risk statistic, a scaling based on a confidence level of the risk statistic and a selected extreme period return of an asset, at block 602.

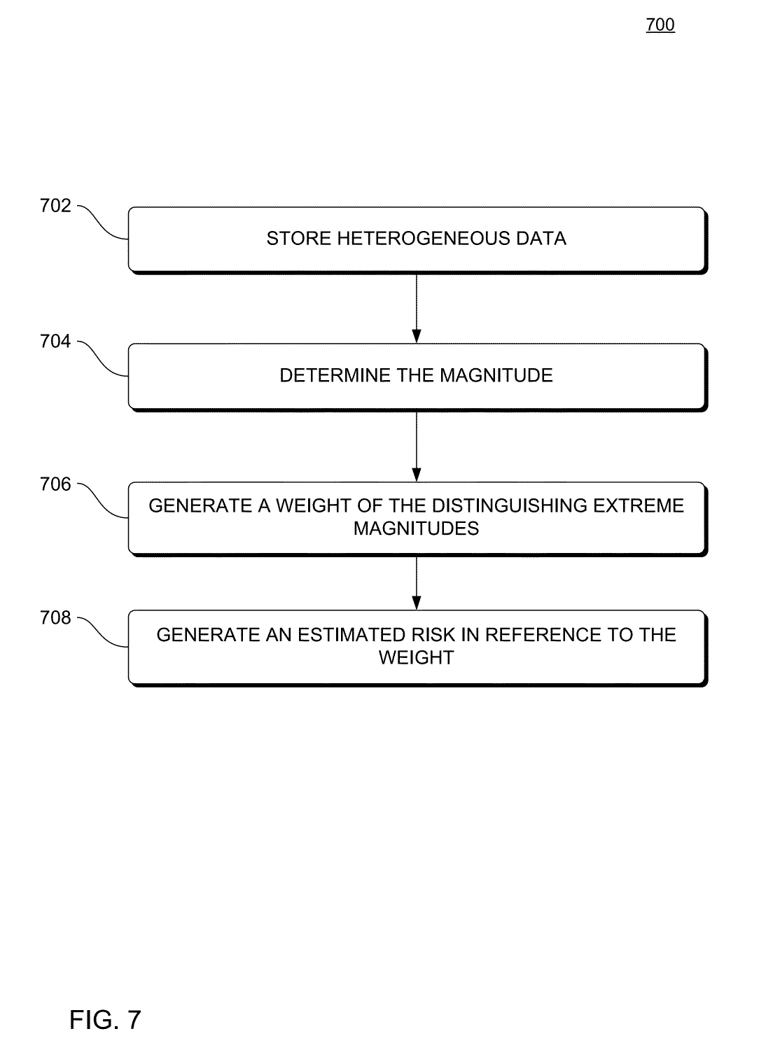

FIG. 7 is a flowchart of a method 700 of determining variance in heterogeneous data. The heterogeneous data includes a time dimension and a magnitude dimension. Some implementations of method 700 include storing an electronically accessible database of the heterogeneous data in a system. The system includes at least one computing device with a processor and memory. The memory stores executable instructions that are executable by the processor, at block 702. Some implementations of method 700 include determining the magnitude dimension that is associated with the time dimension having distinguishing extreme magnitudes of the heterogeneous data in the electronically accessible database. The magnitude dimension is associated with the time dimension as two dimensions in a two-dimensional Cartesian graph. The distinguished extreme magnitudes being stored in the memory of the system, at block 704. In some implementations of determining the magnitude dimension that is associated with the time dimension having distinguishing extreme magnitudes includes identifying data of the heterogeneous data that has the magnitude dimension that is greater than a cutoff. In some implementations the cutoff is 2 standard deviations of the heterogeneous data of the electronically accessible database of the system.

In some implementations, the magnitude dimension is a performance parameter. Some implementations of method 700 include generating a weight of the heterogeneous data of the time dimension having the distinguishing extreme magnitudes in the memory of the system more than the heterogeneous data outside of the time dimension distinguishing extreme magnitudes of the heterogeneous data in the memory of the system, at block 706. One implementation of generating the weight is method 400 in FIG. 4.

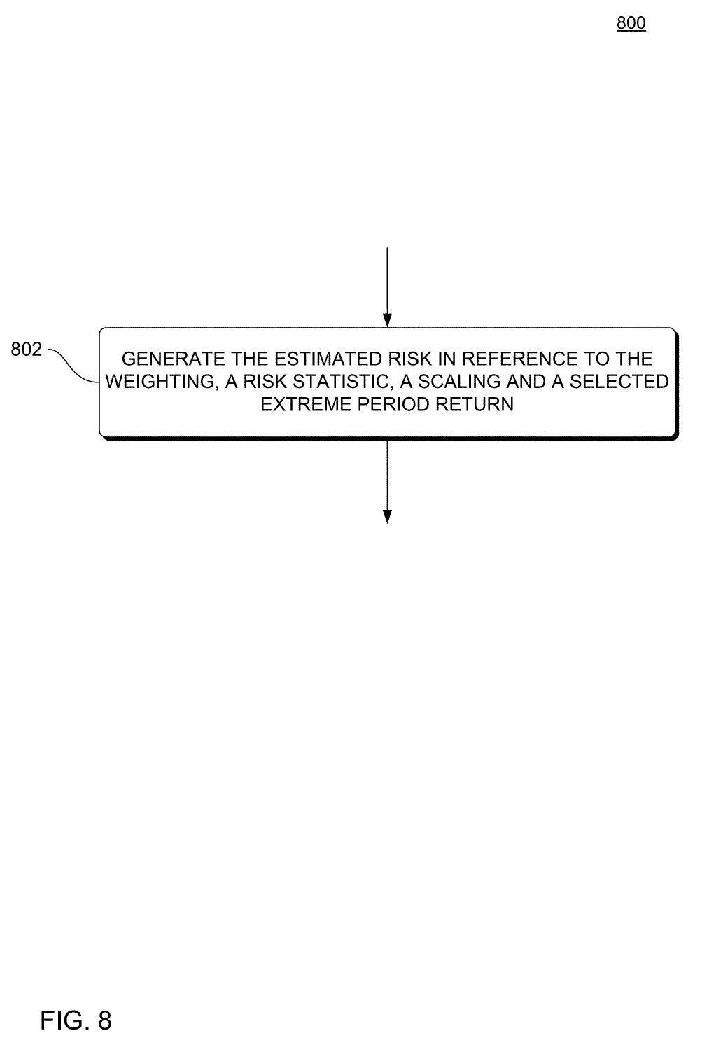

Some implementations of method 700 include generating an estimated risk of the heterogeneous data in the electronically accessible database in the system in reference to the weight in the memory of the system, at block 708. One implementation of generating the estimated risk is method 800 in FIG. 8.

FIG. 8 is a method 800 of generating the estimated risk of the heterogeneous data in the electronically accessible database in the system in reference to the weight in the memory of the system. Method is one example of generating an estimated risk at block 708 in FIG. 7. Method 800 includes generating the estimated risk in reference to a number of factors, at block 802. The factors include the weight of the heterogeneous data of the time dimension having the distinguishing extreme magnitudes in the memory of the system, a risk statistic, a scaling based on a confidence level of the risk statistic and a selected extreme period return of an asset.

In some implementations, methods 200-800 are implemented as a computer data signal embodied in a carrier wave, that represents a sequence of instructions which, when executed by a processor, such as processing units 904 in FIG. 9, cause the processor to perform the respective method. In other implementations, methods 200-800 are implemented as a computer-accessible medium having executable instructions capable of directing a processor, such as processing units 904 in FIG. 9, to perform the respective method. In varying implementations, the medium is a magnetic medium, an electronic medium, or an optical medium.

### Hardware and Operating Environment

FIG. 9 is a block diagram of a hardware and operating environment 900 in which different implementations can be practiced. The description of FIG. 9 provides an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 9 illustrates an example of a general computer environment 900, in accordance with an implementation of the disclosed subject matter. The general computer environment 900 includes a computation device 902 capable of implementing the processes described herein. It will be appreciated that other devices can alternatively used that include more components, or fewer components, than those illustrated in FIG. 9.

The illustrated operating environment 900 is only one example of a suitable operating environment, and the example described with reference to FIG. 9 is not intended to suggest any limitation as to the scope of use or functionality of the implementations of this disclosure. Other well-known computing systems, environments, and/or configurations can be suitable for implementation and/or application of the subject matter disclosed herein.

The computation device 902 includes one or more processors or processing units 904, a system memory 906, and a bus 908 that couples various system components including the system memory 906 to processor(s) 904 and other elements in the environment 900. The bus 908 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 906 includes nonvolatile read-only memory (ROM) 910 and random access memory (RAM) 912, which can or can not include volatile memory elements. A basic input/output system (BIOS) 914, containing the elementary routines that help to transfer information between elements within computation device 902 and with external items, typically invoked into operating memory during start-up, is stored in ROM 910.

The computation device 902 further can include a non-volatile read/write memory 916, represented in FIG. 9 as a hard disk drive, coupled to bus 908 via a data media interface 917 (e.g., a SCSI, ATA, or other type of interface); a magnetic disk drive (not shown) for reading from, and/or writing to, a removable magnetic disk 920 and an optical disk drive (not shown) for reading from, and/or writing to, a removable optical disk 926 such as a CD, DVD, or other optical media.

The non-volatile read/write memory 916 and associated computer-readable media provide nonvolatile storage of computer-readable instructions, data structures, program modules and other data for the computation device 902. Although the exemplary environment 900 is described herein as employing a non-volatile read/write memory 916, a removable magnetic disk 920 and a removable optical disk 926, it will be appreciated by those skilled in the art that other types of computer-readable media which can store data that is accessible by a computer, such as magnetic cassettes, FLASH memory cards, random access memories (RAMs), read only memories (ROM), and the like, can also be used in the exemplary operating environment.

A number of program modules can be stored via the non-volatile read/write memory 916, magnetic disk 920, optical disk 926, ROM 910, or RAM 912, including an operating system 930, one or more application programs 932, other program modules 934 and program data 936. Examples of computer operating systems conventionally employed for some types of three-dimensional and/or two-dimensional medical image data include the NUCLEUS® operating system, the LINUX® operating system, and others, for example, providing capability for supporting application programs 932 using, for example, code modules written in the C++® computer programming language.

A user can enter commands and information into computation device 902 through input devices such as input media 938 (e.g., keyboard/keypad, tactile input or pointing device, mouse, foot-operated switching apparatus, joystick, touchscreen or touchpad, microphone, antenna etc.). Such input devices 938 are coupled to the processing unit 904 through a conventional input/output interface 942 that is, in turn, coupled to the system bus. A monitor 950 or other type of display device is also coupled to the system bus 908 via an interface, such as a video adapter 952.

The computation device 902 can include capability for operating in a networked environment using logical connections to one or more remote computers, such as a remote computer 960. The remote computer 960 can be a personal computer, a server, a router, a network PC, a peer device or other common network node, and typically includes many or all of the elements described above relative to the computation device 902. In a networked environment, program modules depicted relative to the computation device 902, or portions thereof, can be stored in a remote memory storage device such as can be associated with the remote computer 960. By way of example, remote application programs 962 reside on a memory device of the remote computer 960. The logical connections represented in FIG. 9 can include interface capabilities a storage area network (SAN, not illustrated in FIG. 9), local area network (LAN) 972 and/or a wide area network (WAN) 974, but can also include other networks.

Such networking environments are commonplace in modern computer systems, and in association with intranets and the Internet. In certain implementations, the computation device 902 executes an Internet Web browser program (which can optionally be integrated into the operating system 930), such as the “Internet Explorer®” Web browser manufactured and distributed by the Microsoft Corporation of Redmond, Wash.

When used in a LAN-coupled environment, the computation device 902 communicates with or through the local area network 972 via a network interface or adapter 976. When used in a WAN-coupled environment, the computation device 902 typically includes interfaces, such as a modem 978, or other apparatus, for establishing communications with or through the WAN 974, such as the Internet. The modem 978, which can be internal or external, is coupled to the system bus 908 via a serial port interface.

In a networked environment, program modules depicted relative to the computation device 902, or portions thereof, can be stored in remote memory apparatus. It will be appreciated that the network connections shown are exemplary, and other means of establishing a communications link between various computer systems and elements can be used.

A user of a computer can operate in a networked environment 900 using logical connections to one or more remote computers, such as a remote computer 960, which can be a personal computer, a server, a router, a network PC, a peer device or other common network node. Typically, a remote computer 960 includes many or all of the elements described above relative to the computer 900 of FIG. 9.

The computation device 902 typically includes at least some form of computer-readable media. Computer-readable media can be any available media that can be accessed by the computation device 902. By way of example, and not limitation, computer-readable media can comprise computer storage media and communication media.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation device 902.

Communication media typically embodies computer-readable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

System 100 components can be embodied as computer hardware circuitry or as a computer-readable program, or a combination of both. In another implementation, system 100 is implemented in an application service provider (ASP) system.

More specifically, in the computer-readable program implementation, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in general computer environment 900 in FIG. 9, or on at least as many computers as there are components.

Calculating a risk of a financial asset performance data that changes weighting of past returns is described. A technical effect of the accurate instability estimates is precise estimates of risk of the financial asset. Although specific implementations have been illustrated and described herein, it will be appreciated by those of ordinary skill in the art that any arrangement which is calculated to achieve the same purpose may be substituted for the specific implementations shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future communication devices, different file systems, and new data types.

### CONCLUSION

The terminology used in this application is meant to include all object-oriented, database and communication environments and alternate technologies which provide the same functionality as described herein.

1. A method of determining variance in heterogeneous data, the heterogeneous data including a time dimension and a magnitude dimension, the method comprising:
storing an electronically accessible database of the heterogeneous data in a system, the system including at least one computing device with a processor and memory, the memory storing executable instructions that are executable by the processor;
determining the magnitude dimension that is associated with the time dimension having distinguishing extreme magnitudes of the heterogeneous data in the electronically accessible database, the distinguishing extreme magnitudes being stored in the memory of the system;
generating a weight of the heterogeneous data of the time dimension having the distinguishing extreme magnitudes in the memory of the system more than the heterogeneous data outside of the time dimension distinguishing extreme magnitudes of the heterogeneous data in the memory of the system; and
generating an estimated risk of the heterogeneous data in the electronically accessible database in the system in reference to the weight in the memory of the system.

2. The method of claim 1, wherein the magnitude dimension further comprises:
a performance parameter comprising at least one of corporate financial data and stock performance metrics.

3. The method of claim 1, wherein the determining the magnitude dimension that is associated with the time dimension having distinguishing extreme magnitudes further comprises:
identifying data of the heterogeneous data having the magnitude dimension that is greater than a predetermined cutoff value.

4. The method of claim 3, wherein the predetermined cutoff value further comprises:
2 standard deviations of the heterogeneous data of the electronically accessible database of the system.

5. The method of claim 1, wherein generating the weight further comprises:
generating a first divider comprising a reverse divider of a 1 year average price/earnings ratio in a historical sample of average price/earnings ratio;
generating a second divider comprising a divider of a 1 year average junk spread;
generating a third divider comprising a reverse divider of 180-day change in average 1-year junk spreads, at the time at which the price/earnings ratio of the heterogeneous data is observed;
summing the first divider, the second divider and twice the third divider;
dividing the sum by 20, yielding a quotient; and
subtracting 1 from the quotient of the dividing, yielding the weight of the heterogeneous data in the electronically accessible database in the system.

6. The method of claim 1, wherein generating the estimated risk of the heterogeneous data in the electronically accessible database in the system in reference to the weight in the memory of the system further comprises:
generating the estimated risk in reference to the weight of the heterogeneous data of the time dimension having the distinguishing extreme magnitudes in the memory of the system, a risk statistic, a scaling based on a confidence level of the risk statistic and a selected extreme period return of an asset.

7. A method of determining variance in heterogeneous data, the heterogeneous data including a time dimension and a performance measurement, the method comprising:
storing an electronically accessible repository of the heterogeneous data in a system, the system including at least one computing device with a processor and memory, the memory storing executable instructions that are executable by the processor;
identifying unstable periods of the performance measurement of the heterogeneous data of the electronically accessible repository in the system;
generating a weight of the heterogeneous data of the time dimension having the unstable periods of the performance measurement of the heterogeneous data of the electronically accessible repository in the memory of the system; and
generating an instability estimator of a risk statistic of the heterogeneous data of the electronically accessible repository of the system in reference to the weight.

8. The method of claim 7, wherein the identifying further comprises:
identifying data of the heterogeneous data having performance measurement that is greater than a cutoff.

9. The method of claim 8, wherein the cutoff further comprises:
2 standard deviations of the heterogeneous data.

10. The method of claim 7, wherein generating the weight further comprises:
generating a first divider comprising a reverse divider of a 1 year average price/earnings ratio in a historical sample of average price/earnings ratio;
generating a second divider comprising a divider of a 1 year average junk spread;
generating a third divider comprising a reverse divider of 180-day change in average 1-year junk spreads, at the time at which the price/earnings ratio of the heterogeneous data is observed;
summing the first divider, the second divider and twice the third divider;
dividing the sum by 20, yielding a quotient; and
subtracting 1 from the quotient of the dividing, yielding the weight of the heterogeneous data in the electronically accessible repository in the system.

11. The method of claim 7, wherein generating the instability estimator of the risk statistic of the heterogeneous data in the electronically accessible repository in the system in reference to the weight in the memory of the system further comprises:
generating the instability estimator in reference to the weight of the heterogeneous data of the time dimension having the unstable periods in the memory of the system, a risk statistic, a scaling based on a confidence level of the risk statistic and a selected extreme period return of an asset.

12. The method of claim 7, wherein the heterogeneous data further comprises:
financial data.

13. A system comprising:
a processor;
a storage device coupled to the processor, operable to store heterogeneous financial data of an item and variance rules;
a weighting engine that is operable on the processor to receive, distinguish and identify extreme heterogeneous financial data and over-weight the extreme heterogeneous financial data; and
an analytical engine that is operable on the processor to receive the over-weighted extreme heterogeneous financial data, the variance rules, and the heterogeneous financial data, and operable on the processor to perform the variance rules on the heterogeneous financial data using the over-weighted extreme financial data to generate or yield an instability estimator.

14. The system of claim 13, wherein the heterogeneous financial data further comprises:
securities data.

15. The system of claim 13, wherein the variance rules further comprise:
value-at-risk variance rules.

16. The system of claim 13, wherein the analytical engine further comprises:
a leading indicator of future periods of extreme activity of the item measured by the heterogeneous financial data.

17. The system of claim 13, wherein identify further comprises:
identify a subset of the heterogeneous financial data having performance measurement that is greater than a cutoff.

18. The system of claim 17, wherein the cutoff further comprises:
2 standard deviations of the heterogeneous financial data.

19. The system of claim 13, wherein generating the weight further comprises:
generating a first divider comprising a reverse divider of a 1 year average price/earnings ratio in a historical sample of average price/earnings ratio;
generating a second divider comprising a divider of a 1 year average junk spread;
generating a third divider comprising a reverse divider of 180-day change in average 1-year junk spreads, at a time at which the price/earnings ratio of the heterogeneous data is observed;
summing the first divider, the second divider and twice the third divider;
dividing the sum by 20, yielding a quotient; and
subtracting 1 from the quotient of the dividing, yielding the weight of the heterogeneous data in the storage device.

20. The system of claim 13, wherein generating the instability estimator of the heterogeneous financial data in the storage device in reference to the weight further comprises:
generating the instability estimator in reference to the weight of the heterogeneous financial data having unstable periods in the storage device, a scaling based on a confidence level of the risk statistic and a selected extreme period return of the item.
